(19) United States
(12) Patent Application Publication
(10) Pub. No.: US 2025/0145136 A1
(43) Pub. Date: May 8, 2025

(54) HYDRAULIC MULTI-CIRCUIT POWER BRAKE SYSTEM

(71) Applicant: Robert Bosch GmbH, Stuttgart (DE)

(72) Inventors: Andreas Weh, Sulzberg (DE); Martin Hagspiel, Rettenberg (DE); Matthias Mayr, Rettenberg (DE)

(21) Appl. No.: 18/695,250

(22) PCT Filed: Jan. 26, 2023
(86) PCT No.: PCT/EP2023/051908

§ 371 Date: Mar. 25, 2024

(30) Foreign Application Priority Data
Feb. 23, 2022 (DE) 10 2022 201 867.2

(51) Int. Cl. B60T 13/66; B60T 8/34; B60T 8/40; B60T 8/94

(52) U.S. Cl. CPC B60T 13/662; B60T 8/345; B60T 8/409; B60T 8/94; B60T 2270/413

(57) ABSTRACT

An electrohydraulic multi-circuit power brake system for autonomous driving. The power brake system includes a piston-cylinder unit for each brake circuit, using which the brake circuits are connected to a common power brake pressure generator. In the event of a failure of the power brake pressure generator, the power brake system can be actuated with a hydraulic pump of a slip control system of the vehicle brake system.

### FIELD

The present invention relates to a hydraulic multi-circuit power brake system.

### BACKGROUND INFORMATION

Hydraulic power brake systems generate hydraulic brake pressure for actuating wheel brakes with external power, for which purpose a piston is displaced in a cylinder of a piston-cylinder unit by an electric motor via a worm gear, for example.

European Patent Application Nos. EP 1 970 271 A1 and EP 2 641 788 A1 describe power brake systems with the special feature that the cylinder for power braking is designed as a dual circuit cylinder for a hydraulically separate connection of two brake circuits like a master brake cylinder of a dual circuit vehicle brake system. Like a dual circuit master brake cylinder, the power braking cylinder comprises two pistons disposed coaxially one behind the other and spaced apart in the cylinder, of which a first piston, also referred to as a primary piston or rod piston, is displaced by an electric motor via a ball screw drive, and a second piston, also referred to as a secondary piston or floating piston, is acted upon by the hydraulic brake pressure generated by the first piston, as a result of which the second piston generates the same brake pressure.

### SUMMARY

A hydraulic multi-circuit power brake system according to the present invention includes a plurality of brake circuits, each with one or more hydraulic wheel brakes, and a first hydraulic power brake pressure generator to which the brake circuits are connected via a respective piston-cylinder unit for each brake circuit. According to an example embodiment of the present invention, the power brake system does not have to have a second or further power brake pressure generator. First piston sides of pistons of the piston-cylinder units communicate with the power brake pressure generator such that the first piston sides of the pistons of the piston-cylinder units are acted upon by a hydraulic brake pressure generated by the power brake pressure generator. Second piston sides of the pistons of the piston-cylinder units facing away from the first piston sides communicate with the respective brake circuit such that the brake circuits are acted upon by a brake pressure which prevails on the second piston sides of the cylinders of the piston-cylinder units. The brake pressures in the brake circuits can be equal to and the same as the brake pressure generated by the power brake pressure generator. By using stepped pistons in the piston-cylinder units, for instance, different brake pressures and/or brake pressures other than the brake pressure generated by the power brake pressure generator can also be generated in the brake circuits.

The piston-cylinder units of the power brake system according to the present invention, or their pistons, hydraulically separate the brake circuits from one another and from the first power brake pressure generator.

The power brake system according to the present invention is intended for use in motor vehicles driving on public roads autonomously up to the levels of automation Level 4 and Level 5. Level 4 means high automation; i.e., the vehicle is controlled by a system that can request a driver to take control of the vehicle if it can no longer manage the driving tasks. Level 5 is the highest level and means full automation; in other words there is no need for a driver. Such a vehicle can do without a steering wheel and pedals, but the presence of a steering wheel and pedals is not excluded. The power brake system according to the present invention can also be used in lower levels of automation as well as in non-autonomous driving.

Further developments and advantageous embodiments of the present invention are disclosed herein.

According to an example embodiment of the present invention, the vehicle brake system preferably comprises a slip control, for example with a hydraulic pump, which can be used as a redundant second power brake pressure generator for generating a hydraulic power brake pressure if the first power brake pressure generator fails.

Muscle power actuation of the power brake system according to the present invention, for example with a muscle power actuatable master brake cylinder, is not provided, but is also not excluded by the present invention. Possible, but also not mandatory, is a setpoint generator for a braking force or for the brake pressure to be generated with the power brake pressure generator, which can be operated by the driver with a control element, for example a foot brake pedal or a hand brake lever.

All features disclosed in the description and the FIGURE can be implemented individually or in fundamentally any combination in embodiments of the present invention. Embodiments of the present invention which do not comprise all but only one or more features of an embodiment of the present invention are possible in principle.

### BRIEF DESCRIPTION OF THE DRAWING

The present invention is explained in more detail in the following with reference to an embodiment shown in the FIGURE.

FIG. 1, the sole FIGURE, shows a hydraulic circuit diagram of an electrohydraulic multi-circuit power brake system according to an example embodiment the present invention.

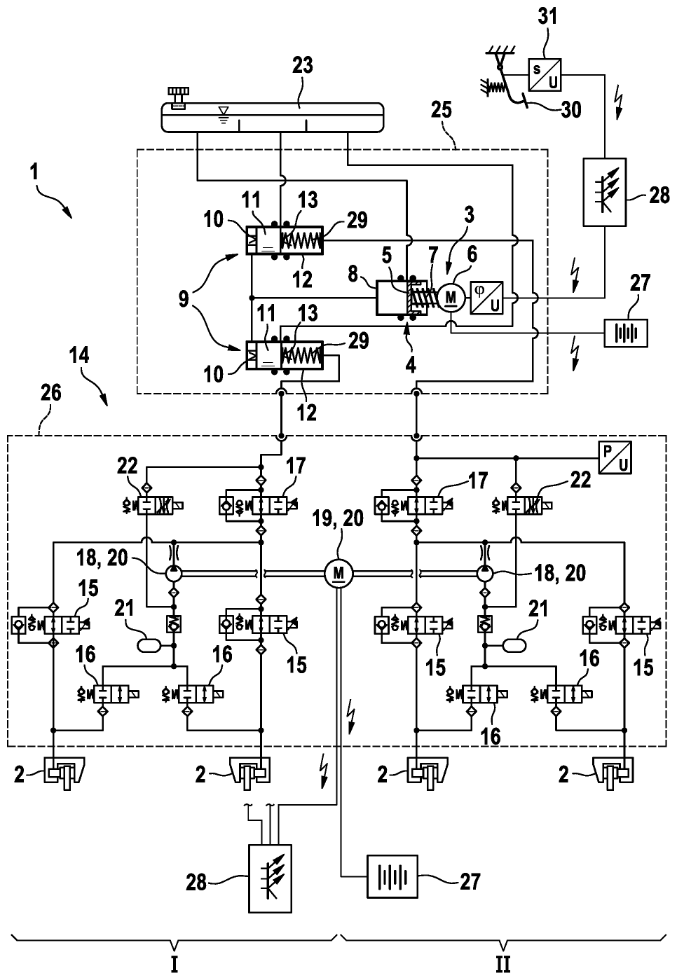

### DETAILED DESCRIPTION OF EXAMPLE EMBODIMENTS

The hydraulic multi-circuit power brake system 1 according to an example embodiment of the present invention shown in the FIGURE is a dual circuit brake system with two hydraulic brake circuits I, II. It is intended for use in a motor vehicle with four hydraulic wheel brakes 2, of which two wheel brakes 2 at a time are associated with a respective brake circuit I, II.

The power brake system 1 according to the present invention is intended for use in a motor vehicle driving on public roads autonomously up to the levels of automation Level 4 and Level 5. Level 4 means high automation; i.e., the motor vehicle is controlled by a system that can request a driver to take control if it can no longer manage the driving tasks. Level 5 is the highest level and means full automation; in other words there is no need for a driver. Such a vehicle can do without a steering wheel and pedals, but the presence of a steering wheel and pedals is not excluded. The power brake system 1 according to the present invention can also be used in lower levels of automation as well as in non-autonomous vehicles.

To generate hydraulic power brake pressure, the power brake system 1 comprises a first power brake pressure generator 3 which, in the embodiment example, is electrohydraulic. The first power brake pressure generator 3 comprises a piston-cylinder unit 4, the piston 5 of which can be displaced in a cylinder 8 of the first piston-cylinder unit 4 by a first electric motor 6 via a worm gear 7 to generate brake pressure. In the embodiment example, the worm gear 7 is a ball screw drive and can generally also be regarded as a rotation/translation converter gear. A planetary gear can be disposed between the first electric motor 6 and the worm gear 7 as a reduction gear, for instance (not shown). Because of the first electric motor 6, the first power brake pressure generator 3 can also be regarded as an electrohydraulic power brake pressure generator 3 and because of its electrohydraulic power brake pressure generator 3, the power brake system 1 can be regarded as an electrohydraulic power brake system 1.

Two second piston-cylinder units 9, each of which is associated with one of the two brake circuits I, II, are connected hydraulically in parallel to the first power brake pressure generator 3, i.e., to the cylinder 8 of the first piston-cylinder unit 4. The two second piston-cylinder units 9 are connected to the first power brake pressure generator 3 such that first piston sides 10 of pistons 11 of the second piston-cylinder units 9 are acted upon by a brake pressure generated by the first power brake pressure generator 3 and the brake circuits I, II are connected to the second piston-cylinder units 9 such that they are acted upon by a hydraulic pressure which prevails on the second piston sides 13 of the pistons 11 in cylinders 12 of second piston-cylinder units 9. The two second piston-cylinder units 9 associated with the brake circuits I, II therefore communicate with the first power brake pressure generator 3 and the two brake circuits I, II communicate with the second piston-cylinder units 9 associated with them.

The pressure on the second piston sides 13 of the pistons 11 of the second piston-cylinder units 9 is generated by pressurizing the first piston sides 10 with the brake pressure generated by the power brake pressure generator 3 and, in the embodiment example, is the same as the brake pressure generated by the power brake pressure generator 3. The use of stepped pistons, for instance, which have differently sized piston surfaces on their first piston side and second piston side, makes it possible to generate a different pressure on the second piston sides 13 and thus in the brake circuits I, II than the brake pressure generated by the power brake pressure generator 3 and/or generate different brake pressures in the two brake circuits I, II (not shown).

In the embodiment example, the piston 5 of the first piston-cylinder unit 4 of the first power brake pressure generator 3 has a larger piston surface than the pistons 11 of the second piston-cylinder units 9 associated with the two brake circuits I, II, as a result of which a pressure reduction takes place between the first power brake pressure generator 3 and the brake circuits I, II and a travel boost takes place between the piston 5 of the first piston-cylinder unit 4 of the first power brake pressure generator 3 and the pistons 11 of the second piston-cylinder units 9 associated with the brake circuits I, II. However, this is not mandatory for the present invention.

The power brake system 1 comprises a slip control system 14 with a respective inlet valve 15 and outlet valve 16 for each wheel brake 2. The wheel brakes 2 are connected to the cylinders 12 of the second piston-cylinder units 9 via the inlet valves 15, wherein a separator valve 17 is disposed in each brake circuit I, II between the second piston-cylinder unit 9 associated with the brake circuit I, II and the inlet valves 15. The brake circuits I, II are acted upon by the brake pressure on the second piston sides 13 of the pistons 11 of the second piston-cylinder units 9.

The wheel brakes 2 in each brake circuit I, II are connected via the outlet valves 16 to a suction side of a hydraulic pump 18, wherein the two hydraulic pumps 18 of the two brake circuits I, II can be driven by a common second electric motor 19. Together with the second electric motor 19, the hydraulic pumps 18 form second power brake pressure generators 20. Pressure sides of the hydraulic pumps 18, which are part of the slip control system 14, are connected between the separator valves 17 and the inlet valves 15. A hydraulic accumulator 21 for intermediate storage of brake fluid from the wheel brakes 2 during slip control is provided on each of the suction sides of the hydraulic pumps 18. The suction sides of the hydraulic pumps 18 are furthermore connected to the cylinders 12 of the second piston-cylinder units 9 via suction valves 22 on the second piston sides 13.

The inlet valves 15, outlet valves 16, separator valves 17 and suction valves 22 are 2/2-way solenoid valves, wherein the inlet valves 15 and the separator valves 17 are open in their currentless home positions and the outlet valves 16 and suction valves 22 are closed in their currentless home positions. The slip control system 14 enables wheel-specific brake pressure control in the wheel brakes 2. In particular slip control systems, such as antilock control, traction slip control and vehicle dynamics control, for which the abbreviations ABS, TCS and VDC are commonly used, are possible. Such slip control systems are conventional and will not be discussed here in more detail.

The second power brake pressure generators 20 with the second electric motor 19 and the hydraulic pumps 18 of the slip control 14 ensure redundancy; i.e., the hydraulic brake pressure can alternatively be generated with the second power brake pressure generators 20 if the first power brake pressure generator 3 fails. This ensures the availability of the power brake system 1 according to the present invention even if the first power brake pressure generator 3 fails, thus making the power brake system 1 suitable for autonomous driving.

The cylinder 8 of the first piston-cylinder unit 4 of the first power brake pressure generator 3 and the cylinders 12 of the second piston-cylinder units 9 on the second piston sides 13 of their pistons 11 are connected to a brake fluid reservoir 23, wherein, when they are displaced out of a home position to generate the brake pressure, the pistons 5, 11 pass over openings of brake lines from the brake fluid reservoir 23 to the cylinders 8, 12 such that the pistons 5, 11 hydraulically separate the cylinders 8, 12 from the brake fluid reservoir 23 at the beginning of their displacement as is conventional in muscle power actuatable master brake cylinders.

In the embodiment example of the present invention, the power brake system 1 has a modular structure: The first power brake pressure generator 3 and the two second piston-cylinder units 9 are associated with or housed in a first module, which is referred to here as the pressure generation module 25, and the slip control 14 is associated with or housed in a second module, which is referred to here as the pressure control module 26. It is also possible, for example, to house the first power brake pressure generator 3, the two second piston-cylinder units 9 and the slip control 14 in one module (not shown). The housing of the components of the power brake system 1 according to the present invention in one or more modules is not essential to the present invention.

For reasons of redundancy, the pressure generation module 25 and the pressure control module 26 each have their own electrical power supply 27 and their own electronic control unit 28, which ensures the availability of the power brake system 1 in the event of a failure in the pressure generation module 25 or in the pressure control module 26 or the slip control system 14. In the embodiment example, the power supplies 27 include accumulators.

The second piston-cylinder units 9 associated with the brake circuits I, II comprise piston return springs 29, which act on the pistons 11 in the direction of their home positions that are occupied by the pistons 11 in the cylinders 12 when the power brake system 1 is unactuated and unpressurized. By connecting the second piston-cylinder units 9 to the first piston-cylinder unit 4 of the first power brake pressure generator 3, the second piston-cylinder units 9 likewise act hydraulically on the piston 5 of the first power brake pressure generator 3 in its home position, which is why the first piston-cylinder unit 4 does not require a piston spring or piston return spring and also does not have one in the embodiment example.

It is also possible to return the piston 5 of the first piston-cylinder unit 4 of the first power brake pressure generator 3 by hydraulically pressurizing the second power brake pressure generator 20.

In the embodiment example, the piston 5 of the first piston-cylinder unit 4 of the first power brake pressure generator 3 is connected in a tension-resistant and pressure-resistant manner to the worm gear 7 which forms the rotation/translation converter gear in such a way that the piston 5 can also be returned to its home position electromechanically with the first electric motor 6 via the worm gear 7.

As a setpoint generator for the brake pressure to be generated with the first power brake pressure generator 3, the power brake system 1 comprises a spring-loaded foot brake pedal 30 with a displacement sensor 31, or optionally a force sensor. For redundancy, it is also possible to provide a plurality of displacement sensors or force sensors or one displacement sensor 31 and one force sensor (not shown). In principle, it is possible to provide a muscle power actuatable master brake cylinder for auxiliary actuation of the vehicle brake system 1 if the first power brake pressure generator 3 fails (not shown). In the drawn embodiment example, the power brake system 1 does not comprise a master brake cylinder and cannot be actuated with muscle power. Because of the ability to generate the brake pressure with either the first power brake pressure generator 3 or the second power brake pressure generator 20, the power brake system 1 is suitable, even without the option of muscle power actuation, for autonomous driving in which the power brake system 1 has to be autonomously actuatable without actuation by a driver.

1-9. (canceled)

10. A hydraulic multi-circuit power brake system, comprising:
a plurality of brake circuits, each brake circuit of the plurality of brake including at least one hydraulic wheel brake and a first hydraulic power brake pressure generator; and
a second piston-cylinder unit for each brake circuit, wherein first piston sides of pistons of the second piston-cylinder units communicate with the first hydraulic power brake pressure generator and second piston sides of the pistons of the second piston-cylinder units each communicate with one of the brake circuits.

11. The hydraulic multi-circuit power brake system according to claim 10, wherein the first hydraulic power brake pressure generator includes a first piston-cylinder unit, a piston of which can be displaced in a cylinder of the first piston-cylinder unit by a first electric motor via a worm gear or a rotation/translation converter gear to generate a power brake pressure.

12. The hydraulic multi-circuit power brake system according to claim 10, further comprising:
a second power brake pressure generator with which a hydraulic brake pressure can be generated as an alternative to generating brake pressure with the first hydraulic power brake pressure generator.

13. The hydraulic multi-circuit power brake system according to claim 12, further comprising a slip control system which includes the second power brake pressure generator.

14. The hydraulic multi-circuit power brake system according to claim 12, further comprising:
a first power supply and/or a first electronic controller for the first hydraulic power brake pressure generator; and
a second power supply and/or a second electronic controller for the second power brake pressure generator.

15. The hydraulic multi-circuit power brake system according to claim 11, wherein the piston of the first piston-cylinder unit of the first hydraulic power brake pressure generator has a larger piston surface than the pistons of the second piston-cylinder units that communicate with the brake circuits.

16. The hydraulic multi-circuit power brake system according to claim 12, wherein: (i) the second piston-cylinder units that communicate with the brake circuits include piston return springs which act on their pistons with the effect of a lowering of pressure in the brake circuits that communicate with them, and/or (ii) the piston of the first piston-cylinder unit of the first hydraulic power brake pressure generator does not include a piston spring.

17. The hydraulic multi-circuit power brake system according to claim 11, wherein the piston of the first piston-cylinder unit of the first hydraulic power brake pressure generator is connected in a tension-resistant and pressure-resistant manner to the worm gear or rotation/translation converter gear in such a way that the piston can be displaced in the cylinder of the first piston-cylinder unit of the first hydraulic power brake pressure generator by the first electric motor via the worm gear or the rotation/translation converter gear in two opposite directions.

18. The hydraulic multi-circuit power brake system according to claim 10, wherein the power brake system does not include actuation by muscle power.
